(19) United States
(12) Patent Application Publication
(10) Pub. No.: US 2012/0102123 A1
(43) Pub. Date: Apr. 26, 2012

(54) INVITATION MANAGEMENT SYSTEM AND METHOD

(76) Inventor: David B. Tysk, Eden Prairie, MN (US)

(21) Appl. No.: 13/094,061

(22) Filed: Apr. 26, 2011

Related U.S. Application Data
(60) Provisional application No. 61/327,759, filed on Apr. 26, 2010.

(51) Int. Cl. G06F 15/16

(52) U.S. Cl. 709/206

(57) ABSTRACT

A computerized system is presented to manage invitations to an event. An event organizer presents an opportunity to at least one host to utilize the tickets, while also defining invitation templates for the event. Hosts that accept the tickets use the template to invite guests to use the tickets. If a host rejects the tickets, the tickets are made available to the next host in a queue list. If a host cannot use all of the potential tickets to an event, the system will offer those tickets to other hosts. Similarly, invitations to a guest that are rejected are presented to a next guest on a queue list. The system can present deadlines for responding to an invitation. Furthermore, the system can impose guest requirements on an invited guest, making it clear that the invited guest must bring along one or more additional guests in order to accept the invitation.

### FIELD OF THE INVENTION

The present application relates to the field of event and invitation management. More particularly, the described embodiments relate to a computerized system and method for promoting events through a three-tiered system handling invitations between an event organizer, a plurality of event hosts, and invitees or guests.

### SUMMARY

Many companies and organizations use special events to promote their products and services. The ability to interact with clients in an informal setting is highly valued, as relationships that are developed while watching a baseball game or golf tournament together are often stronger than relationships that are strictly professional. Since strong relationships with clients and prospective clients frequently lead to increased business, these events become a crucial client development tool for many different organizations. In order to attract people, these events are frequently of very high quality—and very expensive. Tickets to a professional sporting event such as a golf tournament frequently cost more than $100. Consequently, when a company purchases a large block of tickets, it is very important that these tickets be used as effectively as possible.

To make the best possible use of the event tickets that it purchases, many companies will assign a staff member to serve as an event organizer for the event. This organizer is responsible for ensuring that the tickets are distributed effectively. The organizer will have several goals in mind when distributing the tickets. First, the tickets should go primarily to clients and potential clients of the firm (i.e., “guests”), since the primary purpose of acquiring the tickets is to promote the company to these guests. Second, it is likely that the guests to be invited are known only to individual representatives or employees of the company. For instance, in a law firm the most desired guests will be known only by the individual attorneys working at the firm, while in a financial services firm those guests will be known to different financial advisors. It is therefore important that the invitations come directly from these company representatives. This allows the professional who is the guest's primary contact with the firm to act as the host for the event. Consequently, a second goal to be met by the event organizer is to spread the tickets equitably between the different hosts within the company. The third goal is to ensure that as many tickets as possible to the event get used. An unused ticket not only costs the company the value of the ticket, but also the lost opportunity of marketing the company to a client or potential client.

The system and method described below utilizes a programmed computer to allow an event organizer and individual hosts to manage invitations to an event so as to help meet these goals. With this computerized system, the event organizer can provide access to tickets to various professionals, who can then use the event to personalize their marketing efforts to their guests. In many cases, these professionals will work for or otherwise represent the same company as the event organizer, but this does not always need to be the case.

Using the described system, professionals are informed of the opportunity to use the tickets for marketing purposes through the computerized system. The professional may turn down the opportunity, in which case the tickets can timely be made available to another potential host. If the professional accepts this opportunity, the system will help the professional extend invitations to one or more potential guests (which may include both existing and potential clients). Invitation content created by the event organizer can be used by the professional as the basis for their own invitation to their guests. One benefit of the described system is its ability track invitations and acceptances made to both potential professional hosts and to potential guests. Invitations that are rejected will free up tickets for other potential attendees and professionals.

The described system tracks the invitations. This means that the system can provide information regarding when an invitation has been sent, when the invitation was viewed by the guest, when and whether an invitation has been accepted or rejected, and when an invitation has been pending for a period of time without any response from the guest. The system can also track attendance at the event, and even the results of the marketing performed at the event. In this way, the system can track the effectiveness of different types of events, as well as the marketing effectiveness of individual hosts.

Of course, although this description refers to “tickets” or “event tickets,” frequently no actual tickets are used or distributed either to the guests directly or for admission to an event. As a result, the term “ticket” in this description should be read broadly to mean available space at an event. For example, an organization that is hosting a seminar may not issue any physical tickets to the seminar, but will nonetheless be very interested in maximizing attendance up to the space limitations of the seminar location. These available spaces will be made available for hosts to use for guest invitations, as described herein.

Furthermore, the word “guest” in this description should also be read broadly to mean any potential invitee to an event. Such potential invitee could be a client, a prospective client or prospect, a guest of a client or prospective client, or any other invitee.

### BRIEF DESCRIPTION OF THE DRAWINGS

FIG. 1 is a schematic diagram showing the various parties that may be involved in organizing, hosting, and attending an event.

FIG. 2 is a schematic diagram showing the components of the computerized system and the interfaces used to access the system.

FIG. 3 is a flow chart showing a method used to implement the computerized system.

FIGS. 4 though 15 are screen shots of the organizer interface.

FIGS. 16 through 18 are screen shots of the host or professional interface.

FIG. 19 is a screen shot of the guest interface.

FIG. 20 is a schematic diagram of another embodiment of the present invention.

FIG. 21 is a flow chart showing a method used to implement save-the-date announcements.

### DETAILED DESCRIPTION

### Overview

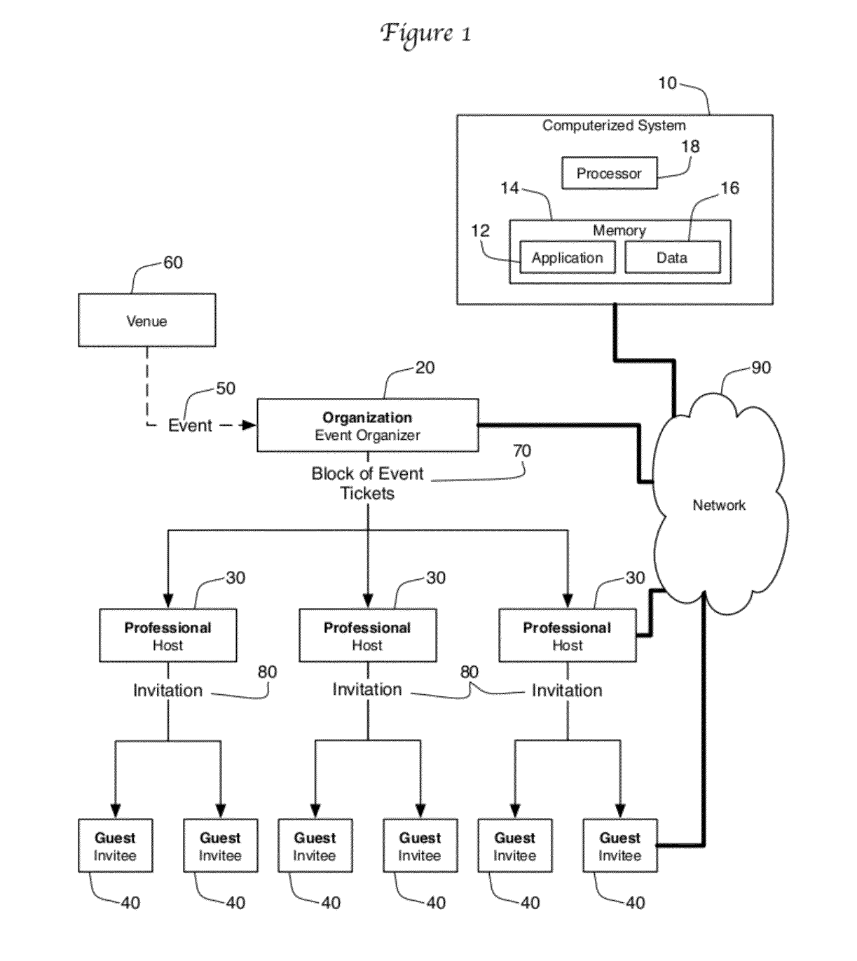

FIG. 1 shows a computerized system 10 that has been programmed to manage invitations to an event. The computerized system 10 is designed to be used by multiple parties simultaneously. These parties include an organization 20 that is responsible for distributing tickets to an event, one or more professionals 30 that are responsible for inviting guests to the event, and the guests 40 that receive and respond to the invitations. The invitations involved generally relate to an event 50 such as a professional sporting event.

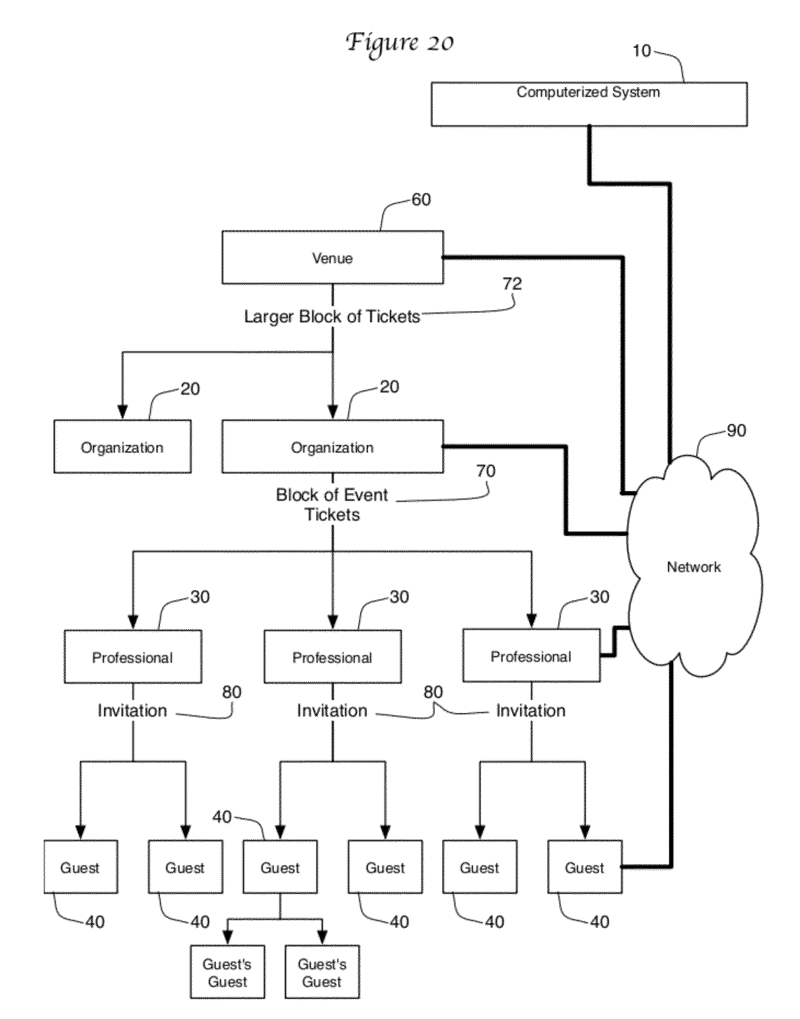

For example, the organization 20 could be a financial services company that purchases a block of tickets to, or a sponsorship tent at, a golf tournament. In that case, the event 50 is actually put on by an external venue 60 that does not use the computerized system 10 (although the venue 60 might use the system in an alternative embodiment described below in connection with FIG. 20). The financial services company may have purchased these tickets so as to give its financial service advisors the opportunity to invite clients, prospective clients, and guests to the event. In this case, the financial services company is the organization 20 shown in FIG. 1 (also known as the event organizer) 20, the individual financial service advisors are the professionals 30 (also known as the hosts), and the clients and prospective clients would be the guests or invitees 40.

The organization 20 or one of its designated employees uses the computerized system 10 to offer the opportunity for the professionals 30 to invite guests 40 to the event 50. These opportunities are typically provided in the form of a block of tickets 70 to the event 50. The professionals 30 use the system 10 to receive and accept these event opportunities. The professionals 30 also use the computerized system 10 to send invitations 80 to the event 50 to a plurality of potential guests 40. In one embodiment, the invitations 80 are sent using e-mail templates. The event organizer 20 customizes these e-mail templates with event-specific content. This allows each professional 30 the ability to send custom e-mail invitations to the event 50 directly to their guests without requiring that each professional 30 separately create their own invitation communications. These e-mail invitations 80 include a link for the guests 40 to access a website provided by the computerized system 10 in order to accept or reject the invitation 80. In another embodiment, the system 10 is designed to track verbal invitations, made by the professional 30 either in person or over the telephone. The system allows the professional 30 to record the verbal invitation, and also to record the response of the guest 40 to that invitation.

Each of these parties interacts with the computerized system 10 through a wide area network 90 such as the Internet. The computerized system 10 preferably consists of one or more server computers each having application programming 12 residing on tangible, non-transitory, computer-readable memory 14 such as RAM, ROM, a physical hard drive, or FLASH memory. The memory 14 also contains data 18 in some type of database on the various parties 20, 30, 40, the event 50, the blocks of tickets 70 presented to the hosts 30, and the individual invitations 80. The application instructions 12 are executed on one or more processor chips 18 on the server computers. This processor chip 18 could be any of the standard, general purpose processors available on the market, such those manufactured by Intel Corporation of Santa Clara, Calif. or Advanced Micro Devices of Sunnyvale, Calif.

### Database

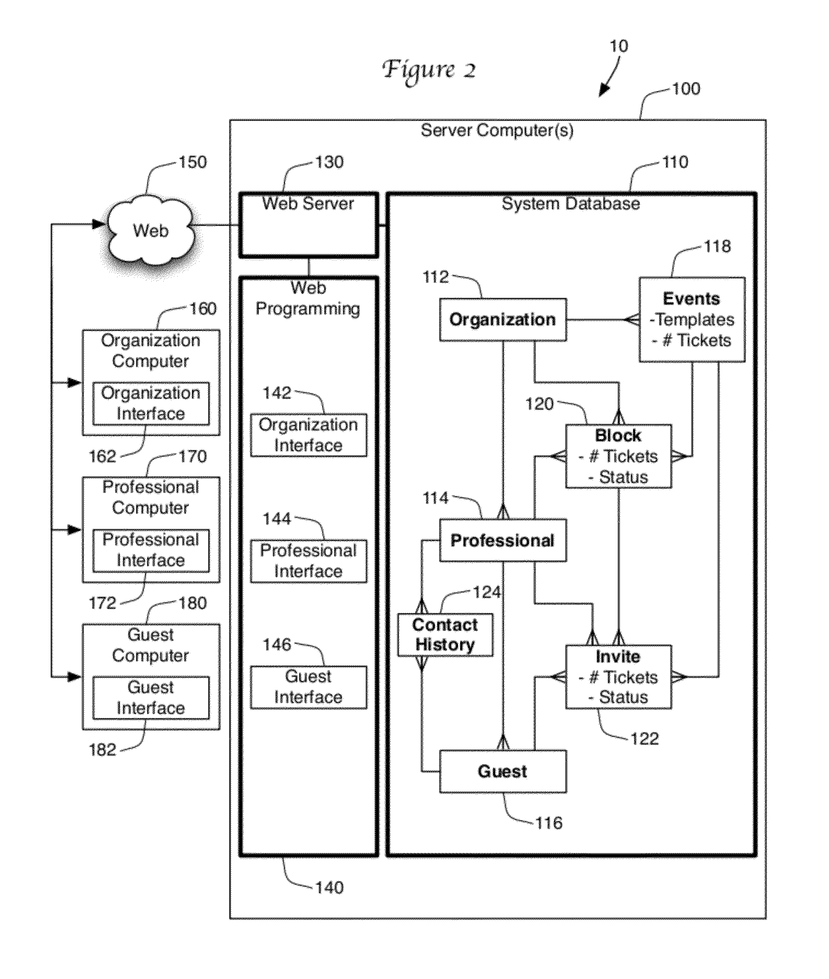

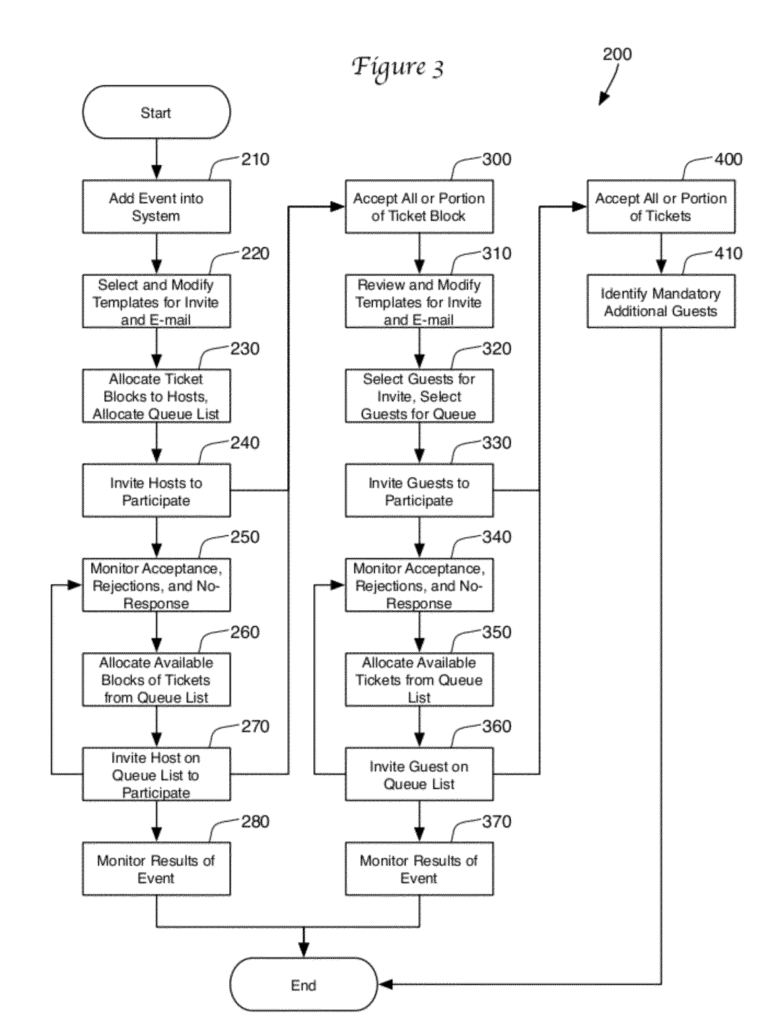

FIG. 2 shows one method in which the data 16 can be stored in a database 110 operating on one or more server computers 100. The information about the parties can be stored in pre-defined fields in a database table (or database objects in an object-oriented database environment) within the database 110. FIG. 2 shows the database 110 with tables or objects for organizations 112, professionals 114, guests 116, events 118, ticket blocks 120, and invitations 122. Relationships between these entities 112-122 are represented in FIG. 2 using crow's foot notation.

The database 110 can keep track of the fact that organizations 112 can organize multiple events 118. Each of these events 118 in the database can include information about the e-mail templates and the numbers of tickets available for the event 118. The organization 112 is able to define multiple ticket blocks 120 and submit these ticket blocks 120 to a variety of professionals 114 for acceptance or rejection. Each ticket block 120 is for a set number of tickets, and has a status associated with it (i.e., has the block of tickets been accepted or rejected, in whole or in part, by the professionals 114, or whether the system is still waiting for a response from the professionals 114). Each block of tickets 120 is associated with the one organization 112 that created it, one professional 114 to which it is directed, and one event 118. The professional 114 can accept the ticket block 120 and uses the tickets in the block 120 to create or send invitations 122 to particular guests 116. Each invitation 122 is associated with the professional 114 that created the invitation 122, and the guest 116 to whom the invitation 122 was sent. The invitation 122 can also be associated with the particular event 118 and even the block of tickets 120 granted to the professional 114 by the organization 112. The system 10 can track the status of each invitation, as well as the number of tickets granted by the professional 114 to the guest 116 in that invitation.

In one embodiment, the database 110 also functions as part of a contact management system allowing contacts to be made between professionals 114 and guests 116. A record of all contacts made by a professional 114 with a guest 116 using the system 10 is maintained in the contact history information 124. This information 124 allows a professional 114 to examine all previous communications and interactions with a guest 116 to determine whether the guest 116 should be invited to a new event 118. In addition, when communications from a professional 114 to a guest 116 are initiated by the system 10, the full content of such communication is stored in the contact history 124. This allows the system 10 to meet regulatory and corporate requirements that all communications with clients and potential clients be archived. In another embodiment, the system 10 is designed to allow individual professionals 114 to determine an automatic copy list (such as a cc or bcc list) for all communications with guests 116. In this embodiment, every communication that is transmitted using the system is e-mailed automatically to the host's automatic copy lists. This allows a professional 114 to track all communications made through the system in another application, such as a personal or corporate e-mail account. It also allows corporations using the system to automatically copy client and potential client communication to a separate system not maintained by the server computers 100, which may also help in regulatory compliance issues.

A web server 130 operating on one or more of the server computers 100 uses the database to generate the various interfaces used by the system 10. In particular, web programming 140 exists that defines how to create an organization interface 142, a professional interface 144, and a guest interface 146 using the data in the database 110. This programming 140 allows the web server 130 to transmit over the World Wide Web 150 an organization interface 162 that can be seen by a browser operating on a computer 160 for the benefit of an event organizer 20. Similarly, the web server 130 can manage a professional interface 172 on a browser operating on a professional computer 170, and a guest interface 182 on a browser operating on a guest computer 180.

### Method

FIG. 3 is a flow chart describing a method 200 by which the computerized system 10 manages the invitations to an event 50. In this method, steps 210-280 relate to the interaction that event organizers 20 have with the computerized system 10. The first step 210 is for the event organizer 20 to add the event 50 by creating an event record 118 in the database 110. The organizer 20 can do this step manually, or, alternatively, the event record 118 can be automatically created by some other database or system. To create the event manually, the organizer 20 would use the organizer interface 162 to interact with the web server 130 and the system database 110. Information about the event would then be added to the event record 118 through this interface 126. Alternatively, a separate system (not shown) might instruct the system database 110 to create the record 118. This other system might be, for instance, a database that tracks the scheduling of an auditorium. When a new event is entered into that other system (such as a concert), a notification is sent to database 110 to create a corresponding event record 118 in order to handle invitations relating to the event.

After the event record 118 is created, the organizer selects or creates an appropriate template to be used by the system 10 to create invitations, announcements, and e-mails concerning the event 50. For example, one e-mail template could be used to announce to the professionals or hosts 30 that a block of tickets 70 for the event 50 is available to them, while another e-mail template could be used to formulate the e-mails that the host 30 uses to send the invitations 80 to the potential guests 40. The e-mail to the guests 40 may include the invitation 80, and may be formatted to include various graphics and Adobe Flash components (Flash is a trademark of Adobe Systems of Mountain View Calif.). Alternatively, the e-mail could include a link to the formal invitation 80, which could include the same graphics and Flash elements but be presented by the server computers 100 as part of the guest interface 182. In any event, the organizer 20 is able to modify standard templates stored in the computerized system 10 to ease in the creation of these e-mails and invitations. In step 220, the organizer 20 selects those templates and modifies the language in the template to related to the particular event 50.

At step 230, the organizer 20 creates blocks of tickets 70 in the database 110 (such as by creating database entities 120) and then selects particular hosts or inviters 30 to receive these blocks of tickets 70 for marketing their services to guests 40. Typically, the organizer 20 divides all of the tickets available for an event 50 into separate blocks of tickets 70 in order to share the tickets simultaneously with a plurality of hosts 30. For example, if one hundred tickets were available to the organizer 20, the organizer 20 may present ten hosts 30 with the ability to use ten tickets each for this event 50. Because it is unlikely that all selected hosts 30 will accept the use of these tickets, the organizer 20 also identifies hosts 30 for a queue list. This queue list will be used if the originally invited hosts 30 do not use all of the available tickets to the event 50.

After the ticket blocks 70 have been allocated to the invited hosts 30 and the queue list of hosts 30 has been established, the computerized system 10 will then send invitations to the invited hosts 30 to utilize these blocks of tickets 120 in step 240. The opportunity to use these ticket blocks can be sent via an e-mail initiated by the computerized system 10 with each e-mail containing a link to the website providing professional interface 172. Alternatively, the invitation can be received directly through the professional interface 172 after the host logs into their account on the server computers 100. This invitation is formatted according to the template selected by the organizer at step 220 using the organizer interface 162. When a host 30 receives such an opportunity, the host 30 may accept all of the tickets, accept a portion of the tickets, reject the tickets, or not respond to the invitation (at step 300). The server computers 100 monitor the response of the hosts 30 at step 250. Generally, each host 30 will have a predetermined amount of time to respond to the opportunity to use the block of tickets 70. When the time is about to expire, the system 10 may send a reminder e-mail or other notification to remind the host 30 that their ability to receive the tickets is about to expire. If the time period does pass, the host 30 is considered to have rejected the block of tickets 70. In some embodiments, this time limit could be set by the organizer 20 using the organizer interface 162, or the time limit can be established according to defaults in the system 10.

Upon the rejection of some or all of the tickets in a block 70 by a host 30, the organizer 20 now has additional tickets available for the event 50. When this is determined in step 250, the system 10 will allocate these available tickets in new blocks 70 to the hosts 30 that the organizer 20 put into the queue list. These queue list hosts 30 are then sent their own invitations to utilize the tickets in step 270, after which these hosts 30 may accept or reject the tickets in step 300. The system 10 will monitor these responses as well at step 250, and if necessary send more invitations to new hosts 30 off of the queue list until a host 30 has accepted all of the tickets. The organizer interface 162 communicates the response of each host 30 to the organizer 20 as well as the current status of the queue list. In one embodiment, the organizer interface 612 allows the organizer to manually handle queue management, deciding when and how rejected ticket blocks 70 are made available to new hosts 30.

At this point, the process for the organizer moves to step 280, in which the results of the event 50 are inputted, monitored, analyzed, and reported out. Because the system 10 monitors how the tickets are used, and can even track which tickets were actually used and the marketing results of those tickets, the system 10 can report to organizers 20 the marketing effectiveness of the event 50. In this way, organizers can compare events 50 with other events 50 to determine which are most effective in marketing the services of the hosts 30. In addition, the system 10 can track the extent to which each host 30 is able to get the tickets in the hands of guests 40 that actually attend the event 50. With this knowledge, the organizer 20 can follow up with hosts 30 to ensure that they make better use of the tickets in the future, or can use this information in the future to allocate blocks of tickets 70 to only those hosts 30 that most effectively use the system 10.

Steps 300-370 relate to the interaction that the professionals or hosts 30 have with the computerized system 10. At step 300, the organizer 20 has invited the host 30 to make use of a block of tickets 70 to forward to their guests. Using interface 172, the host 30 can accept all or a portion of the ticket block 70 (step 300). If any tickets are rejected at step 300, the computerized system 10 reacts to this information at step 250 and reallocates the tickets to hosts 30 on the queue list in step 260. The invitation to use the ticket block 70 comes with a time limit, so if the host does not accept the tickets at step 300 within the time limit, the system will consider the tickets rejected.

If the host accepts tickets at step 300, the host 30 will then use the host interface to review the templates provided by the system for the e-mails and invitations that will be made to the guests 40. In one embodiment, the host 30 has complete control over the look and content of these invitations, and therefore can choose which template to use and make any desired modifications. In other embodiments, only the organizer 20 can select these templates and modify the invitations (as described above in connection with step 220). In those embodiments, step 310 would be skipped. Even when hosts 30 are not allowed to modify the invitations, the invitation templates created by the organizer 20 will be automatically customized for each host 30, so as to include the host's name and relevant graphics.

At step 320, the host 30 then selects the guests 40 that are to be invited to the event 50. As was the case with the organizer 20 selecting hosts 30, the host 30 can associate a particular number of tickets for each guest's invitation, and can also select guests for a queue list. Guests on the queue list will be invited to the event 50 by the system 10 only if the originally invited guests 40 do not accept the invitations. Once the guests 40 are selected and the tickets allocated, the system 10 will invite the selected guests 40 to the event 50.

Because the guests 40 would not be expected to regularly check their guest interface 182 on the server computers 100, the invitations 80 to the guests are generally initiated outside of this interface 182. In one embodiment, the invitation 80 takes the form of an e-mail sent by the computerized system 10 to the guest 40. The e-mail describes the event 50, and encourages the guest 40 to visit a web page for more information about the event or to RSVP to the invitation. The encouragement can take the form of a web link within the e-mail to the guest interface 182 web page. In another embodiment, the invitations can be made verbally. In this case, the host 30 would inform the database 110 that the guest 40 had been invited verbally through the host interface 172. Acceptances or rejections to the verbal invitation would also be entered directly by the host 30 through the host interface 172.

In one embodiment, the host 30 may require that the invited guest 40 bring one or more additional guests with them to the event 50. In this way, the host 30 can use the event to not only reestablish a connection with existing clients, but to also meet potential new clients. In order to ensure that some potential new clients will attend the event 50, the invitation 80 will require that the invited guest 40 bring one or more additional guests to the event 50. When a guest 40 accesses the guest interface 182 to accept such an invitation, the guest 40 will be asked by the system 10 to identify their mandatory additional guests (step 410). The computerized system 10 can be designed to prevent the final acceptance of tickets at step 400 until the mandatory additional guests are identified. In addition, the system 10 can also allow the guest to bring additional guests as an option, without any requirement that the additional guests be mandated.

After the guests 40 are invited at step 330, the system 10 will monitor the response to the invitations 80 at step 340. This step will track the tickets that have been accepted and rejected by the guests 40, and will track whether the time period for a guest 40 to accept an invitation 80 has expired. Before that time period has completed, the system 10 can be programmed to send out reminders stating that the invitation will have to be withdrawn if the guest 40 does not respond by the deadline. To the extent that this monitoring step 340 identifies that tickets have been rejected by invited guests 40, the system 10 will allocate the available tickets to guests 40 on the guest queue list at step 350, and then send out invitations to those guests at step 360. The system will then monitor the response to those invitations at step 340, and if necessary send out more invitations for unused tickets to additional guests 40 on the guest queue list.

At step 370, the host 30 inputs the results of the event 50 into the system using the host interface 172. In one embodiment, this takes place simply by tracking which guests 30 do not show for an event 50. In other embodiments, the host 30 will input the number of attendees, the number of existing clients among the attendees, the number of potential new clients among the attendees, and even the number of new clients obtained through potential client leads generated through the event. In this way, the host 30 will gain a better understanding of the types of events 50 that are of interest to their clients and are best suited for new client generation.

### Interfaces

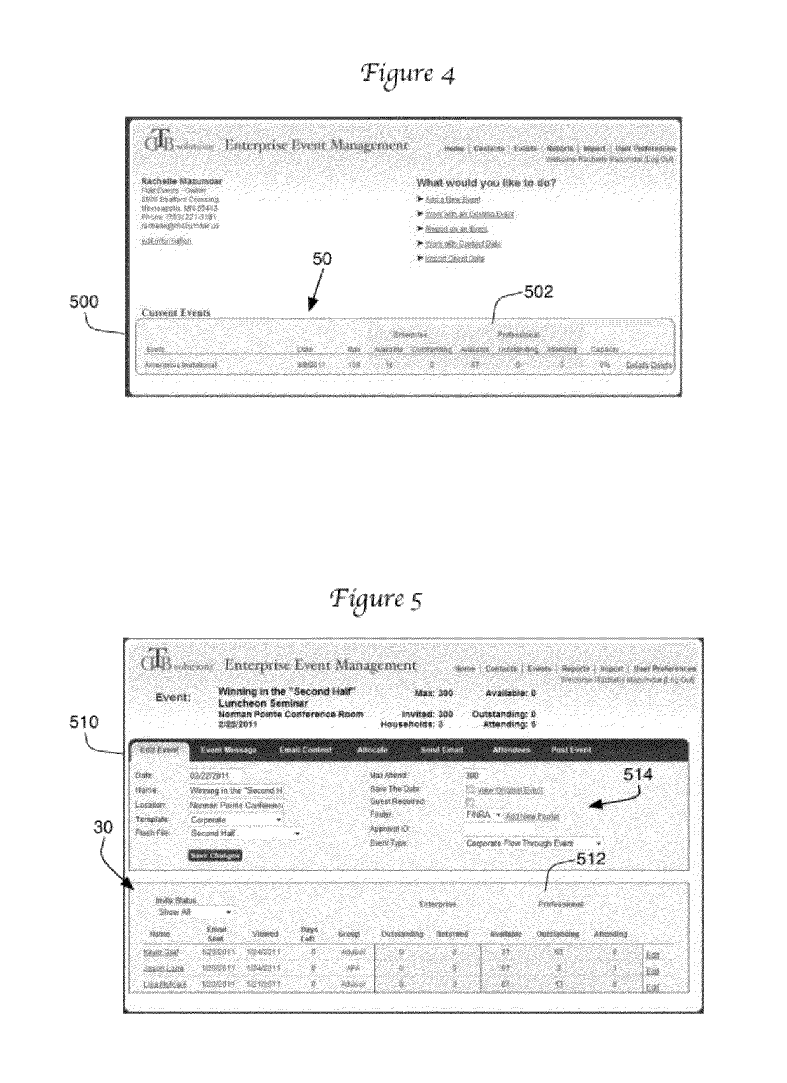

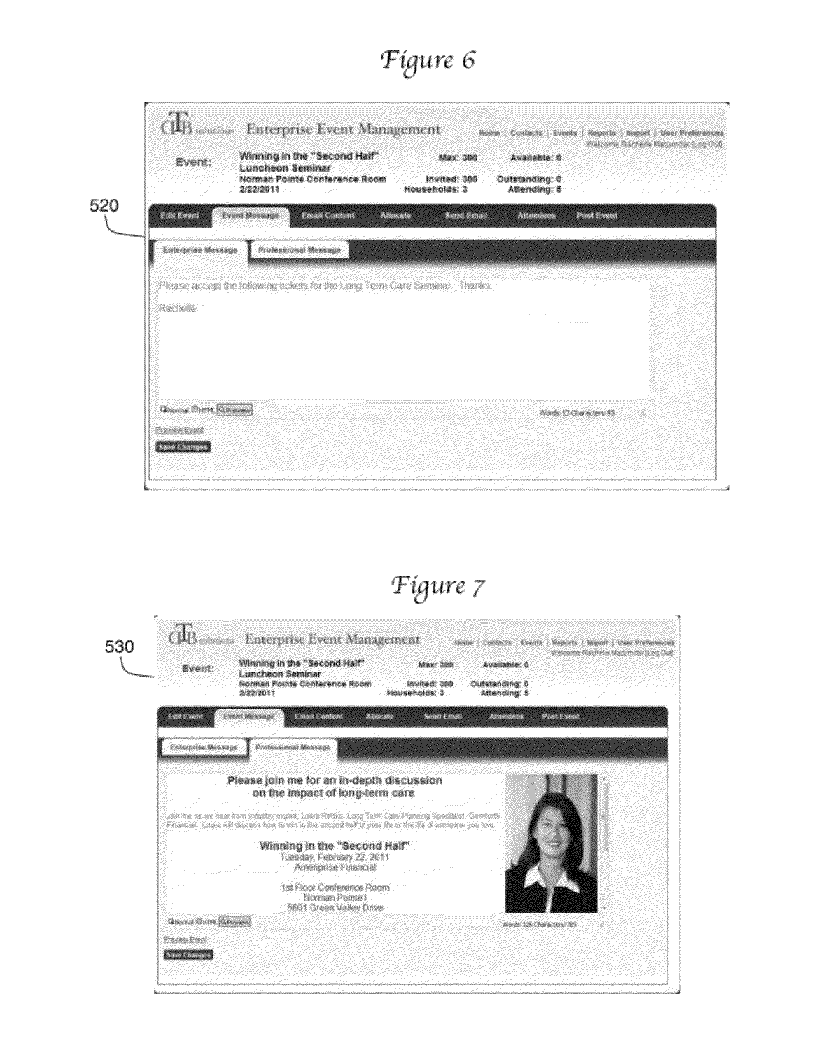

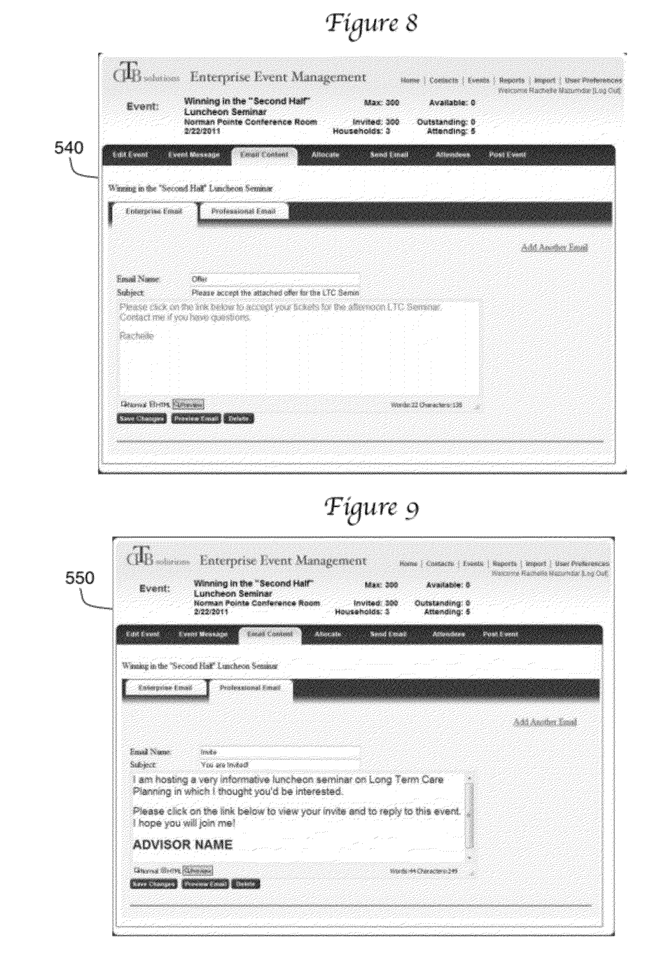

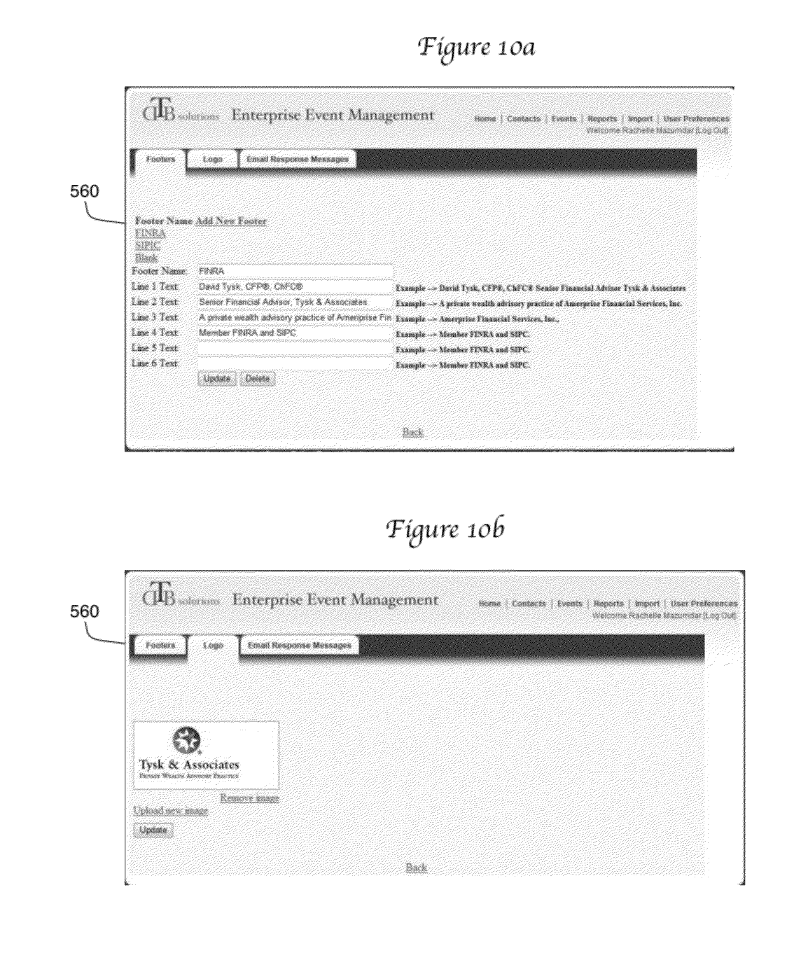

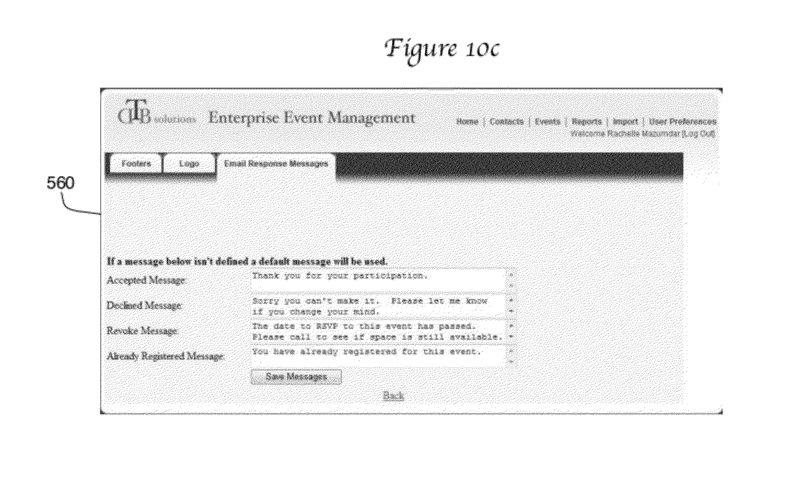

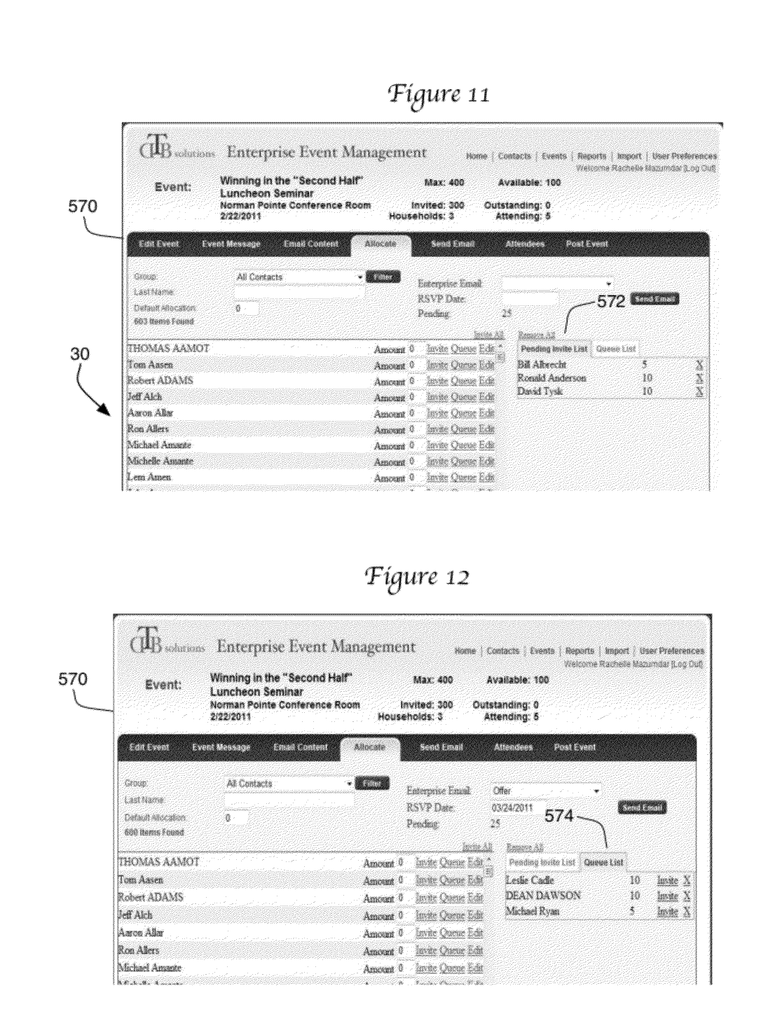

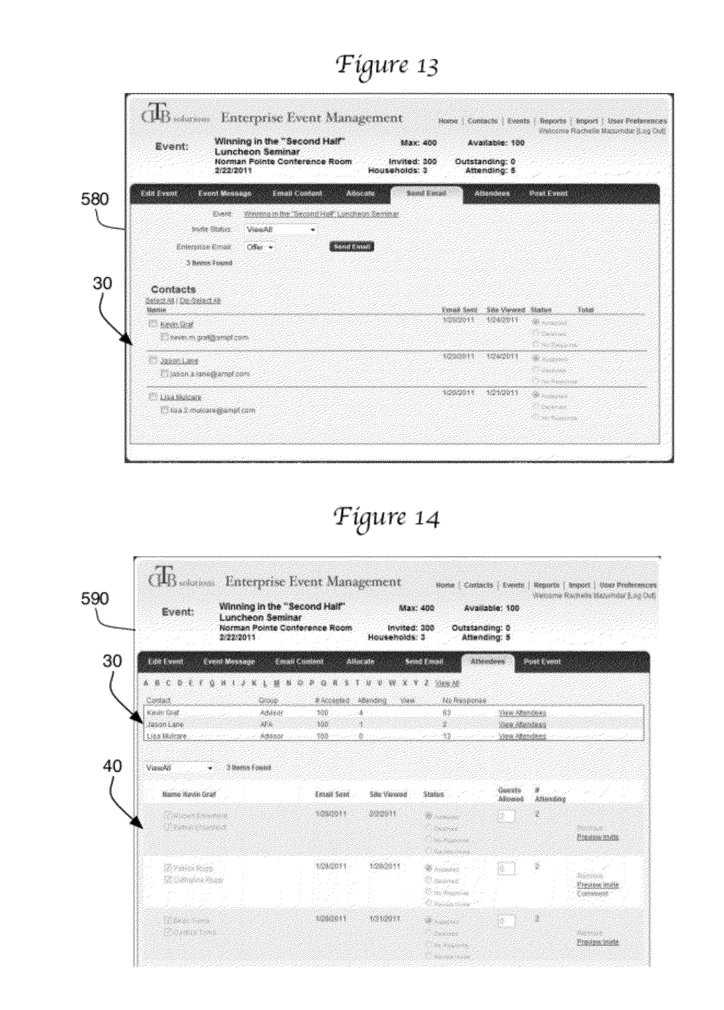

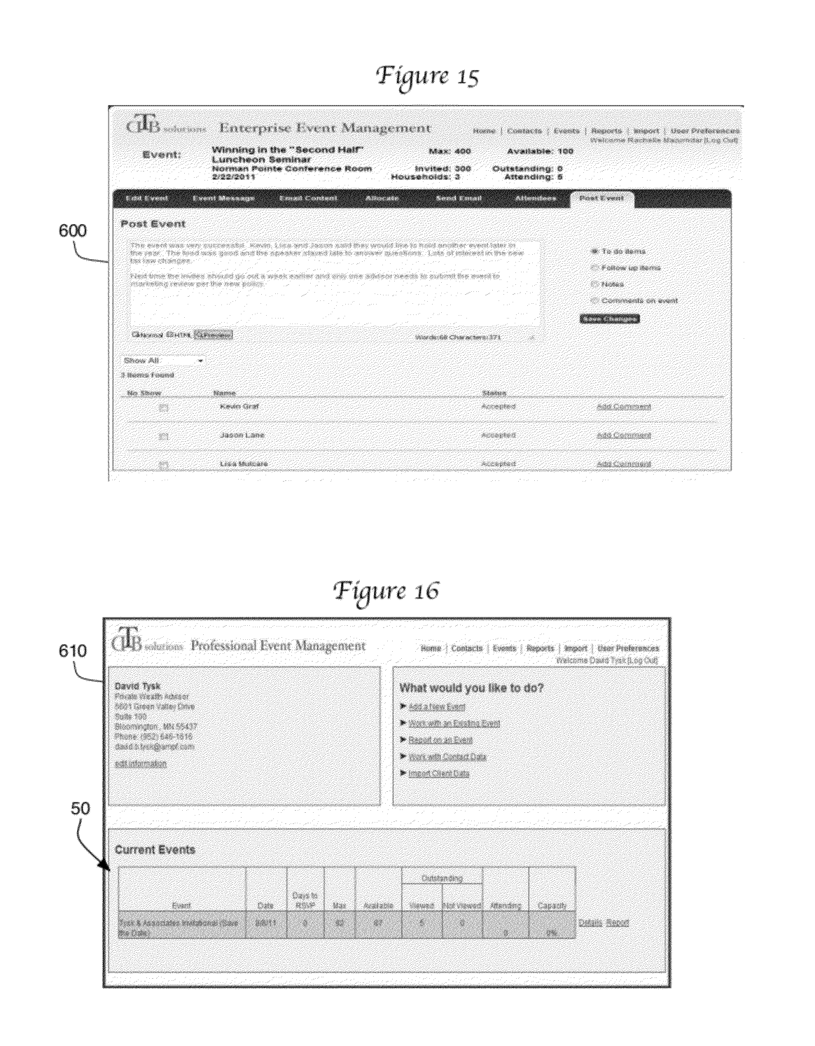

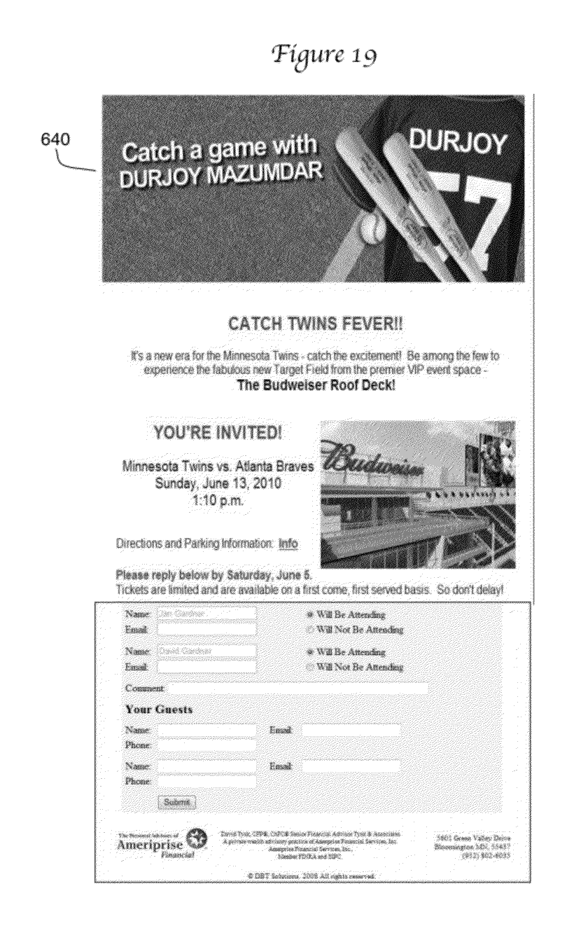

FIGS. 4-15 shows a variety of example screen shots from one embodiment of the organizer interface 162. Similarly, FIGS. 16-18 show example screen shots from the host interface 172, and FIG. 19 shows an example screen shot from the guest interface 182.

In FIG. 4, screen 500 presents the organizer 20 with a list 502 of events 50 currently being managed by the computerized system 10. Included in that list 502 is the total number (max) tickets available for that event, and the current number of tickets that have been accepted for that event 50 by the various hosts 30. The system 10 can even track how many of the hosts 30 have viewed the formal invitation to the event 50 (“views”), and the percentage of tickets that have been accepted (“% Capacity”). The organizer is also able to add a new event 50 to the system 10, look at the details of an existing event, or develop a report on the success or status of an event 50 already in the system 10.

In FIG. 5, screen 510 shows the interface used for an organizer to add a new event 50 or to edit an existing event 50. For previously defined events, the screen 510 will contain a list 512 of hosts 30 invited to participate in the event 50. Each row in this list also shows high-level information about the invitations 80 sent by each host 30 to their guests 40. Using fields 514, the organizer 20 can establish a name and date for the event, select templates, choose graphic images and flash files to be used in the invitations for the event, identify the number of tickets available for the event, and even indicate whether the event should require that invited guests 40 bring an additional guests.

Screen 520 shown in FIG. 6 shows the event message that is created for the event using the templates plus added custom content about the event. Screen 530 in FIG. 7 shows a similar event message, differing in that screen 530 shows the event message presented to the guest 40 including the name of the professional or host 30 in the message, while screen 520 shows the message presented to the host 30 containing the name of the organizer 20.

Similarly, screen 540 in FIG. 8 shows the e-mail message to be sent to the host 30 inviting them to accept the block of tickets 70, while screen 550 in FIG. 9 shows the e-mail message to be sent to the guest 40 inviting them to accept the invitation 80. The e-mail message templates shown in FIGS. 8 and 9 are used to send the invitations to the hosts 30 and guests 40 respectively, and can be edited as necessary by the organizer 20. In the preferred embodiment, sample language for the e-mails can be pre-populated into these e-mail templates when the organizer 20 selects a template for the event 50 in screen 510. Screen 510 also gives the organizer the ability to select a footer for the e-mail messages. An example of such a footer and the screen 560 used to define the footer is shown in FIG. 10a. FIG. 10b shows a screen in which the organizer 20 can select a logo for inclusion in these messages. FIG. 10c gives organizers 20 the ability to define e-mail response messages to be sent upon a user accepting or declining an invitation, or upon expiration of the RSVP time period, or even upon an attempt to re-register for an event.

FIGS. 11 and 12 show the allocation screen 570 used by the organizer 20 to allocate blocks of tickets 70 to particular hosts 30. Hosts 30 are selected from a database of hosts 30 (i.e., an “address book”) that can be associated with the organizer 20. In this way, multiple organizers 20 can use the system 10 to distribute tickets to events 50, with each organizer 20 being able to select hosts 30 from their own personal address book of potential hosts 30. To assist in allocating blocks of tickets 70, screen 570 can present a list of all hosts 30 associated with the current organizer 20. The organizer 20 would then only need to add the number of tickets to be allocated to a particular host (or designate a default number), and then determine whether the host will be added to the invite list 572 or the queue list 574. In FIGS. 11 and 12, three hosts 30 are on the invite list 572 and three hosts 30 are on the queue list 574.

Once the allocation is completed, screen 580 (FIG. 13) can be used to send the e-mails to the hosts on the invite list 572. Screen 580 can also be used to determine whether the hosts 30 have responded to this invite.

To monitor who will be attending the event, the organizer 20 can examine the attendee screen 590, shown in FIG. 14, which shows a list of hosts 30 invited to the event 50. In some embodiments, the organizer 20 can select a particular host 30 and see the guests 40 that have been invited by the host 30. This allows the organizer 20 to judge the success of the event 50 and the individual marketing efforts of the various hosts 30. As a side benefit, the organizer 20 may use the system 10 to create attendance lists and nametags for an event 50.

In other embodiments, it may be important for the organizer 20 to have no access to the names or contact information of the guests 40 invited by the host 30. For instance, a host 30 may treat their client and prospective client list as highly proprietary and would not want to share this information with any other party. In these circumstances, it would be important for the computerized system 10 to maintain the confidentiality of this information. Consequently, the organizer interface 162 may not contain or share any information about these guests 40 with the organizer 20. After the event 50 is completed, the organizer 20 can input to do items, follow up items, notes, and comments about the event in the post event screen 600 shown in FIG. 15.

Screen 610 in FIG. 16 shows one portion of the host interface 172. In this screen 610, the host 30 can see the events 50 for which the host 30 has been invited to accept a block of tickets 70. In addition to handling events to which the host 30 has been invited to participate, the system 10 may also be designed to allow each host 30 to create their own event 50 in the system even without the presence of an organizer 20. As shown in FIG. 15, this ability can be implemented by adding an “add a new event” option to screen 610. The host interface 172 could then allow the host 30 to add event information much as was described above in connection with the organizer interface 162. The list of events 50 shown on this screen 610 would then include both events 50 established by an organizer 20, and the events 50 created by the host 30.

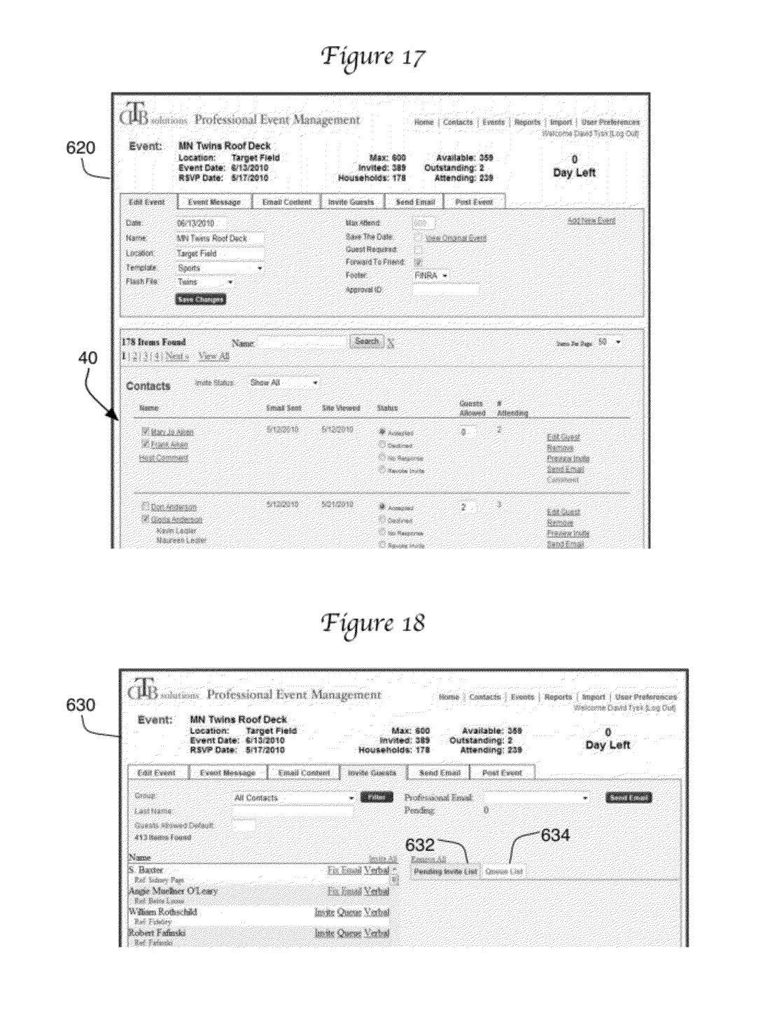

In screen 620 (FIG. 17), the host 30 can see details about an event 50 including the same type of information presented to the organizer in screen 510. The system 10 can be designed to allow the host 30 to enter and change information in this screen 620 as they see fit. Alternatively, the information can be viewed by the host 30 but can only be modified by the organizer 20 in screen 510. If the host 30 were allowed to create a new event 50, this would take place in this screen 620. Screen 620 will also show any guests 40 that have been invited to the event 50, and the status of their response to the invitation 80.

Screen 630 shown in FIG. 18 allows the host 30 to invite guests 40 to the event 50. The host's address book shows a list of potential guests, and then allows the host 30 to indicate whether the guest 40 should be placed on the guest invite list 632 or the guest queue list 634. This screen also allows the host 30 to indicate when a guest 40 has been verbally invited to an event 50. When a verbal invitation has been extended, it will be up to the host 30 to indicate in the system 10 whether the guest 40 accepted or rejected the invitation. Although not shown in the Figures, the host interface 172 could also allow the host 30 to alter the e-mail and event message content presented to the guests 40. This would occur through screen similar to the organizer screens 530 and 550 Alternatively, only the organizer 20 could be given the ability to alter these messages.

Finally, screen 640 in FIG. 19 shows the guest interface 182 presented to guests 40 when they utilize the computerized system 10. The interface 182 presents the guest with information about the event 50, typically in the format designed by the organizer using screen 530. Interface 182 gives the invited guest 40 the opportunity to indicate whether or not they will be attending the event 50. If additional guests are allowed in the invitation 80, the guest 40 can provide the name of the additional guests in screen 182. As mentioned above, the system 10 can be designed to require the invited guest to bring along one or more additional guests. In these cases, screen 640 would indicate that it is a requirement to bring along one or more additional guests, and would require that the guest name and contact information be provided before the invitation could be accepted.

In the above-described embodiments, the computerized system 10 allows an organization or event organizer 20 to manage invitations to a plurality of professionals or hosts 30 for a block of tickets 70, while also allowing the professional 30 to manage invitations to a plurality of guests 40 for a subset of the tickets in the block of tickets 70. In this manner, the above embodiments are in effect a three-tiered system, with the first tier being the organization or event organizer 20, the second tier being the professional or host 30, and the third tier being the guest 40. In the real world, the event organizer 20 could be an event organizer for a financial services company, the hosts 30 could be individual financial advisors working for the same financial services company, and the guests 40 could be clients and prospective clients of the financial advisors.

In FIG. 20, the block diagram of FIG. 1 is reproduced to show a four-tiered embodiment for the present invention. In this case, the top tier may be the venue 60, such as an auditorium or theater. Alternatively, the top tier 60 could be a professional sports team or other entity that is responsible for distributing most or all of the tickets to an event. The venue 60 may then present a large block of tickets 72 to a plurality of organizations 20, such as financial services companies, law firms, and others that may want to use the event 50 to market to clients and prospective clients. The computerized system 10 could be used to help the venue 60 market the event 50 by inviting the various organizations 20 to purchase a block of tickets in exactly the same way that the system allows the organizations 20 to distribute tickets to the hosts or professionals 30. In other words, large block of tickets 72 to an event could be simultaneously offered to multiple organizations 20. If the organization 20 accepts this larger block of tickets 72, it could then offer those tickets to its professionals 30 for use in client development. If the organization 20 rejects the offer for the larger block of tickets 72, the venue 60 could make the block available to another organization 20. Furthermore, the venue 60 could create and modify templates for each event 50, allowing organizations 20 to reuse those templates for its invitations to professionals 30 and guests 40. Obviously, the same technique could be used to add a fifth tier to the system if that was appropriate. Each of the tiers can use the computerized system 10 to handle invitations to the lower tiers by creating invitation lists and queue lists for the next lower tier. The bottom tier (the guests 40) would use the system 10 to simply accept or reject the invitation to the event 50. As shown in FIG. 20, the guest 40 themselves might invite their own guests 42. In one embodiment, the invitation to “guest's guests” 42 would not use the system 10. However, in other embodiments guests 40 would be requested to use the system 10 to invite mandatory guests 42, with those individuals 42 using the system 10 to accept or reject invitations.

The system 10 can be flexible with the amount of data that flows upwards to the higher-level tiers. Upward data movement could be restricted to prevent the sharing of confidential information. Alternatively, upward data movement could be encouraged to allow organizers to create attendance lists and name tags.

In one embodiment, each layer of a tiered system could use the computerized system 10 to initiate new events that were not proposed from a higher layer. Thus, the organizer 20 could create a new event in the four-tiered system 10 shown in 20 even though the event was not organized or even known to the venue 60. In addition, even though the tiered systems shown in FIGS. 1 and 20 show only a single entity at the top of the tiered pyramid, it is contemplated that multiple top-level entities could co-exist in the same system. For instance, both a professional baseball team and an unrelated symphony orchestra could both use the system 10 as venues 60, and both market to the same organizers 20 simultaneously.

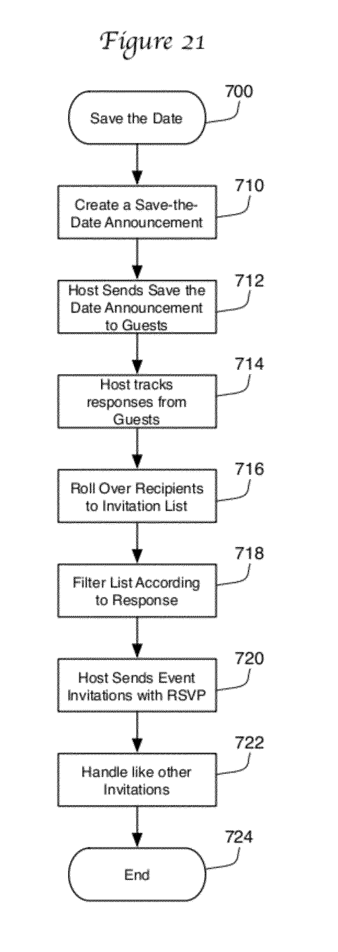

FIG. 21 shows a flowchart describing a save-the-date process 700 used by another embodiment of the present invention. In this process 700, an organization 20 or professional 30 uses the system 10 to create a save-the-date announcement much as they would an event invitation. The purpose of the save-the-date announcement is to let potential guests know that an actual event 50 is being planned and that they should save the date on which the event 50 will take place. The save-the-date announcement is created at step 710 much like an event, using templates, text graphics, and flash files. The professional or host 30 creates a guest list, and then sends the announcement to the guests 40 on the guest list at step 712. Once the save-the-date announcement is sent, the system 10 tracks who has viewed the announcement in the same way the system 10 tracks an invitation. The only difference is that the save-the-date announcement does not enable the guest to respond, or RSVP to the announcement. The “RSVP box” that is included in all event invitations is not included in save-the-date announcements. In some embodiments, the professional 30 can track certain status information about the guests 40 that have received the save-the-date announcement. Some guests 40 will reply to the announcement with an e-mail reply, or call the host about the announcement even though the announcement does not request an RSVP. In this manner, the host 30 may acquire information that some guests 40 will be able to attend, or will not be able to attend the event. The host 30 can capture and log this information (whether the guest 40 accepted or declined the event after the save-the-date announcement, or whether the invitation should otherwise be revoked) on a save-the-date “event edit” screen. The tracking of this information occurs at step 714. In other embodiments, the guest 40 is allowed to use the guest interface 182 to personally respond to the save-the-date announcement with their regrets or by expressing their intent to participate.

Once it is time to send the invitation to the actual event 50, the organization 20 or professional 30 can create an event invitation based on the save-the-date announcement. Not only can the format of the invitation (including the template, text, graphics, and flash files) be based upon the save-the-date announcement and edited as needed, but the guest list from the announcement will also be rolled over to become the guest list for the invitation (step 716). This ensures that the professional 30 does not inadvertently leave any guest 40 off the invitation list who previously received the save-the-date announcement. Information stored by the host in step 714 can then be used to filter the guest list for the invitation in step 718. Therefore, guests 40 who indicated to the host 30 that they cannot attend will not receive a formal invitation to the event 50. Furthermore, guests who previously indicated that they will attend will be sent a reminder notification as opposed to a normal invitation to the event. The reminder may simply remind the guest 40 of the date and time of the event 50. Alternatively, the reminder may allow the guest 40 to access the system 10 and indicate that they now will not be able to attend the event 50. The professional 30 will then send the invitations to the guest list at step 720, and the system will then track guest RSVPs and handle the invitations at step 722 as was described in conjunction with FIG. 3. Both the save-the-date announcement and the event invitation show up in contact history 124 stored for each guest in the database 110.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A server computing apparatus comprising:
a) a processor that processes programming instructions;
b) a non-transitory computer readable memory;
c) database programming stored on the non-transitory computer readable memory and performed by the processor, the database programming managing a database that is transformed during operation by the database programming, the database containing:
i) an event record containing information about an event;
ii) a host record containing information about an associated host for the event, and
iii) a guest record containing information about an associated guest to the event;
d) invitation processing programming stored on the non-transitory computer readable memory and performed by the processor, the invitation processing programming operating to:
i) create an invited host list of invited host records in the database and a queued host list of queued host records in the database,
ii) create an invitation template,
iii) send a communication concerning the event to invited hosts associated with the invited host records,
iv) track responses to the communication to the invited hosts,
v) send communications to queued hosts associated with the queue host records upon a rejection from at least one invited host;
vi) create for an accepting host that accepted the communication an invited list of invited guest records and a queued guest list of queued guest records,
vii) customize the invitation template for the accepting host,
viii) send invitations based on the customized invitation template to invited guests associated with the invited guest records,
ix) track responses to the invitations to the invited guests, and
x) send invitations to queued guests associated with the queued guest records upon a rejection from at least one invited guest.

2. The server computing system of claim 1, wherein the rejection from at least one invited guest is determined by a failure to respond to the invitation within a preset time limit.

3. A method of processing invitations to an event comprising:
a) inputting event information about the event in a computerized system operating a database, the database being stored on a non-transitory computer readable memory and being processed by a computer processor, the event information comprising an event date, an event title, and a total number of tickets;
b) inputting into the database an invited host list of invited hosts, with each invited host being associated with a subset of the total number of tickets;
c) sending a communication through the computerized system to each of the invited hosts, the communication requesting an acceptance of the subset of total number of tickets;
d) tracking responses of the invited hosts through the computerized system, the responses including acceptances and rejections, including a response from an accepting host that accepted a first subset of tickets;
e) inputting into the database an invited guest list of invited guests associated with the accepting host, with each invited guest being associated with a portion of the first subset of tickets;
f) sending an invitation through the computerized system to each of the invited guests, the invitation requesting an acceptance of the portion of the first subset of tickets; and
g) tracking responses of the invited guest through the computerized system.

4. The method of claim 3, wherein the step of inputting into the database an invited host list of invited hosts further comprises inputting into the database a queued host list of queued hosts, further wherein upon the tracking of a rejection from a second invited host associated with a second subset of tickets, and sending a communication through the computerized system to at least one queued host on the queued host list requesting an acceptance of the second subset of tickets.

5. The method of claim 4, wherein the step of inputting into the database an invited guest list of invited guest further comprises inputting into the database a queued guest list of queued guests, further wherein upon the tracking of a rejection from an invited guest associated with a first portion of tickets, and sending a communication through the computerized system to at least one queued guest on the queued guest list requesting an acceptance of the first portion of tickets.

6. The method of claim 5, further comprising:
h) inputting a template associated with the event into the database, the template including elements describing the event;
wherein the steps of sending an invitation through the computerized system further comprises altering the template for the accepting host, and sending the altered template as the invitation so as to present the invitation as coming from the accepting host.

7. The method of claim 3, wherein the step of inputting into the database an invited guest list of invited guest further comprises inputting into the database a queued guest list of queued guests, further wherein upon the tracking of a rejection from an invited guest associated with a first portion of tickets, and sending a communication through the computerized system to at least one queued guest on the queued guest list requesting an acceptance of the first portion of tickets.

8. The method of claim 3, further comprising:
h) inputting a template associated with the event into the database, the template including elements describing the event;
wherein the steps of sending an invitation through the computerized system further comprises altering the template for the accepting host, and sending the altered template as the invitation so as to present the invitation as coming from the accepting host.

9. The method of claim 3, further comprising generating an event organizer interface, a host interface, and a guest interface through a web server operating on the computerized system.

10. The method of claim 10, wherein the organizer interface further comprises:
i) a first organizer interface for inputting event information, and
ii) a second organizer interface for inputting the invited host list.

11. The method of claim 11, wherein the host interface further comprises:
i) a first host interface for submitting responses of the host to the communication, and
ii) a host second interface for inputting the invited guest list.

12. The method of claim 11, wherein the guest interface further comprises:
i) an RSVP interface for submitting a response of the guest to the invitation.

13. The method of claim 12, wherein the step of sending an invitation through the computerized system to each of the invited guests comprises the sending of an e-mail to a plurality of the invited guests with the e-mail containing a web link to the RSVP interface.

14. The method of claim 13, wherein the step of sending an invitation through the computerized system to each of the invited guests further comprises including in the host interface an ability to track of verbal invitations to invited guests as well as rejections and acceptances of verbal invitations.

15. The method of claim 12, wherein the host interface displays the invited guest list updated with an RSVP status for each invited guest.

16. The method of claim 12, wherein the guest interface further comprises an input for identifying an additional guest of the invited guest, wherein the invitation cannot be accepted without identifying the additional guest of the invited guests through the guest interface.

17. The method of claim 9, wherein the organizer interface presents the invited guest list for each accepting host.

18. The method of claim 9, wherein the organizer interface does not disclose the name of the invited guests.

19. The method of claim 3, further comprising:
h) inputting into the database an invited organizer list of invited organizers, with each invited organizer being associated with a block of the total number of tickets;
i) sending a communication through the computerized system to each of the invited organizers, the communication requesting an acceptance of the associated block of tickets; and
j) tracking responses of the invited organizers through the computerized system, the responses including acceptances and rejections, including a response from an accepting organizer that accepted a first block of tickets;
wherein the communication to each of the invited hosts comes from the accepting organizer, further wherein the subset of total number of tickets associated with each invited hosts forms a portion of the first block of tickets.

20. A computer product comprising:
a) a tangible, non-transitory computer memory containing computer programming steps designed to be operated on a computer processor, the computer programming steps comprising:
i) inputting event information about the event in a computerized system operating a database, the database being stored on a non-transitory computer readable memory and being processed by a computer processor, the event information comprising an event date, an event title, and a total number of tickets;
ii) inputting into the database an invited host list of invited hosts, with each invited host being associated with a subset of the total number of tickets;
iii) sending a communication through the computerized system to each of the invited hosts, the communication requesting an acceptance of the subset of total number of tickets;
iv) tracking responses of the invited hosts through the computerized system, the responses including acceptances and rejections, including a response from an accepting host that accepted a first subset of tickets;
v) inputting into the database an invited guest list of invited guests associated with the accepting host, with each invited guest being associated with a portion of the first subset of tickets;
vi) sending an invitation through the computerized system to each of the invited guests, the invitation requesting an acceptance of the portion of the first subset of tickets; and
vii) tracking responses of the invited guest through the computerized system.
